(19) United States
(12) Patent Application Publication
(10) Pub. No.: US 2026/0269142 A1
(43) Pub. Date: Sep. 10, 2026

(54) CAPACITOR

(71) Applicant: Panasonic Intellectual Property Management Co., Ltd., Osaka (JP)

(72) Inventors: Yoshitaka NAKAMURA, OSAKA FU (JP); Kotaro ONO, OSAKA FU (JP); Hitoshi ISHIMOTO, HYOGO KEN (JP)

(21) Appl. No.: 19/167,137

(22) PCT Filed: Feb. 19, 2024
(86) PCT No.: PCT/JP2024/005841

§ 371 Date: Sep. 19, 2025

(30) Foreign Application Priority Data
Mar. 28, 2023 (JP) 2023-051899

(51) Int. Cl. H01G 9/025; H01G 9/048

(52) U.S. Cl. CPC H01G 9/025; H01G 9/048

(57) ABSTRACT

A capacitor includes a first electrode, a dielectric layer formed on a surface of the first electrode, a conductive layer disposed on the dielectric layer, and a second electrode disposed on the conductive layer. The conductive layer includes a needle-like structure made of an inorganic material in a surface layer on the second electrode side.

### TECHNICAL FIELD

The present disclosure relates to a capacitor.

### BACKGROUND ART

Various capacitors have been conventionally proposed. Claim 1 of PTL 1 (Japanese Laid-Open Patent Publication No. 2018-182106) describes “a multilayer ceramic capacitor comprising: a multilayer chip in which dielectric layers mainly composed of ceramic and internal electrode layers are alternately stacked, the multilayer chip having a substantially rectangular parallelepiped shape and being formed such that the stacked internal electrode layers are alternately exposed at opposite two end surfaces; and external electrodes formed on the two end surfaces, wherein the external electrodes have a structure including a base layer and a plating layer formed on the base layer, and at least a portion of a surface of the base layer includes a region in which an average interval between localized peaks is 0.5 μm or less in a region in which a height from a bottom to a peak is 0.4 μm or more”.

Claim 1 of PTL 2 (Japanese Laid-Open Patent Publication No. 2020-35890) describes “a solid electrolytic capacitor comprising: an anode body made of a valve metal; a dielectric layer formed on a surface of the anode body; a semiconductor layer formed on the dielectric layer; and a cathode layer formed on the semiconductor layer, in which the semiconductor layer is constituted by using an inorganic p-type semiconductor”.

### CITATION LIST

### Patent Literature

PTL 1: Japanese Laid-Open Patent Publication No. 2018-182106
PTL 2: Japanese Laid-Open Patent Publication No. 2020-35890

### SUMMARY OF INVENTION

One aspect of the present disclosure relates to a capacitor. The capacitor includes a first electrode, a dielectric layer formed on a surface of the first electrode, a conductive layer disposed on the dielectric layer, and a second electrode disposed on the conductive layer, wherein the conductive layer includes a needle-like structure made of an inorganic material in a surface layer on the second electrode side.

According to the present disclosure, it is possible to obtain a capacitor in which peeling is unlikely to occur between an inorganic layer (a conductive layer) and an electrode.

### BRIEF DESCRIPTION OF DRAWINGS

FIG. 1 is a cross-sectional view schematically showing a structure of an example of a capacitor according to the present embodiment.

FIG. 2 is a cross-sectional view schematically showing a portion of the capacitor shown in FIG. 1.

FIG. 3 is a cross-sectional view schematically showing a structure of another example of the capacitor according to the present embodiment.

FIG. 4A is a cross-sectional image of a surface layer of a zinc oxide layer of an example of a capacitor manufactured in Experiment 1.

FIG. 4B is a cross-sectional image of a surface layer of a zinc oxide layer of another example of a capacitor manufactured in Experiment 1.

FIG. 4C is a cross-sectional image of a surface layer of a zinc oxide layer of another example of a capacitor manufactured in Experiment 1.

FIG. 4D is a cross-sectional image of a surface layer of a zinc oxide layer of another example of a capacitor manufactured in Experiment 1.

FIG. 5 is a cross-sectional image showing an example of measurement results of aspect ratios of needle-like portions.

### DESCRIPTION OF EMBODIMENTS

As described in PTL 2, capacitors including an inorganic layer between two electrodes are known. However, if contact between the inorganic layer and the electrodes is insufficient, peeling occurs between the inorganic layer and the electrode layers, and consequently, there arises a problem such as an increase in the equivalent series resistance (ESR). Under the above circumstances, the present disclosure provides a capacitor in which peeling is unlikely to occur between an inorganic layer (a conductive layer) and an electrode.

Although an embodiment according to the present disclosure will be described below using examples, the present disclosure is not limited to the examples described below. Although specific numerical values and materials may be mentioned as examples in the following description, other numerical values and other materials may be used as long as the invention according to the present disclosure can be implemented. In the present specification, the wording “from a numerical value A to a numerical value B” refers to a range that includes the numerical values A and B, and can be read as “not less than the numerical value A and not more than the numerical value B”. Examples of a lower limit and examples of an upper limit of numerical values relating to a specific physical property or condition described below can be combined suitably as long as the lower limit is not equal to or higher than the upper limit.

### (Capacitor)

A capacitor according to the present embodiment may be hereinafter referred to as a “capacitor (C)”. The capacitor (C) includes a first electrode, a dielectric layer formed on a surface of the first electrode, a conductive layer disposed on the dielectric layer, and a second electrode disposed on the conductive layer. The conductive layer includes a needle-like structure made of an inorganic material in a surface layer on the second electrode side.

As a result of studies, the inventors of the present application newly found a method for forming the conductive layer that includes the needle-like structure made of an inorganic material in the surface layer. By using the conductive layer including the needle-like structure in the surface layer, it is possible to suppress the occurrence of peeling between the second electrode and the surface layer (inorganic layer) having the needle-like structure. Accordingly, it is possible to suppress an increase in the ESR resulting from peeling, for example.

The conductive layer can be formed using an inorganic material. Accordingly, the conductive layer can be read as “inorganic layer”. A preferable example of the conductive layer in the capacitor (C) does not contain an organic material (e.g., a conductive polymer). It is possible to obtain a capacitor (C) that has high heat resistance by using an inorganic material to form the conductive layer.

A portion of the needle-like structure may be embedded in the second electrode. With this configuration, it is possible to firmly fix the inorganic layer and the second electrode by an anchor effect.

In a cross-sectional image of needle-like portions in an end portion of the needle-like structure, an average value As of the aspect ratios may be within a range from 4.6 to 17.2 (e.g., from 5 to 16). The cross-sectional image is an image of a cross section parallel to a thickness direction Dt of the conductive layer. The average value As of the aspect ratios can be determined using a method described in Examples. In the cross-sectional image of the needle-like portions in the end portion of the needle-like structure, the needle-like portions may have a diameter of 0.2 μm or less.

At least a portion of the needle-like portions in the end portion of the needle-like structure may be curved. This configuration particularly increases the anchor effect of the needle-like structure. At least a portion of the needle-like portions may be needle-like crystals. That is to say, the needle-like structure may include needle-like crystals.

The conductive layer may be made of an inorganic material including a metal oxide. In this case, the needle-like structure may be made of the metal oxide. It is possible to obtain a capacitor that has high heat resistance by using the conductive layer made of an inorganic material.

The metal oxide may be a conductive metal oxide that contains at least one selected from the group consisting of ZnO, TiO₂, indium tin oxide, In₂O₃, SnO₂, Ga₂O₃, MnO₂, NiO₂, CuInO₂, CuCrO₂, CuAlO₂, and CuScO₂ as a main component, or may be a conductive metal oxide constituted of the at least one selected from the group. The metal oxide may be a conductive metal oxide that contains any one selected from the above group as a main component, or may be a conductive metal oxide constituted of any one selected from the above group. For example, the metal oxide may be a conductive metal oxide that contains ZnO as a main component, or may be ZnO. Note that ZnO is sometimes classified into semiconductors, but has electrical conductivity, and therefore, is treated as a conductive metal oxide in this specification. Regarding the metal oxide, the term “main component” means that the content of the component is 50% by mass or more. The content of the main component in the metal oxide may be within a range from 80% by mass to 100% by mass, from 90% by mass to 100% by mass, or from 95% by mass to 100% by mass.

The conductive metal oxide described above may include oxygen vacancy. If the conductive metal oxide includes oxygen vacancy, the electrical conductivity of the conductive metal oxide can be increased. When the conductive metal oxide contains zinc oxide (ZnO) as a main component, the zinc oxide contained as the main component may be represented by ZnO₁₋ₓ (0≤x≤0.25). Here, x may be larger than 0.

The conductive metal oxide described above may contain an additional element for improving the electrical conductivity. When the conductive metal oxide contains ZnO as a main component, at least one element selected from the group consisting of Al, Ga, B, and In may be added to ZnO such that the content of the at least one element is 10 atomic % or less.

When the conductive metal oxide contains Ga₂O₃ as a main component, at least one element selected from the group consisting of Ta and Hf may be added to Ga₂O₃ such that the content of the at least one element is 0.1 atomic % or less. When the conductive metal oxide contains TiO₂ as a main component, at least one element selected from the group consisting of Nb and Ta may be added to TiO₂ such that the content of the at least one element is 10 atomic % or less. When the conductive metal oxide contains SnO₂ as a main component, Sb may be added to SnO₂ such that the Sb content is 12.5 atomic % or less. When the conductive metal oxide contains CuCrO₂ as a main component, Mg may be added to CuCrO₂ such that the Mg content is 5 atomic % or less. When the conductive metal oxide contains CuInO₂ as a main component, Ca may be added to CuInO₂ such that the Ca content is 3 atomic % or less.

In the capacitor (C), the first electrode may be an anode and the second electrode may be a cathode. In the capacitor (C), the first electrode may be an aluminum foil or a sintered body of tantalum.

In the capacitor (C), the first electrode may include a porous portion in a surface layer. In this case, the dielectric layer is formed on a surface of the porous portion, and a portion of the conductive layer is within pores in the porous portion. The first electrode including the porous portion in the surface layer may be an etched aluminum foil or a sintered body of a valve metal (e.g., a sintered body of tantalum).

The conductive layer may include a first conductive layer that is in contact with the dielectric layer and a second conductive layer that is in contact with the second electrode. The conductive layer may be constituted of the first conductive layer and the second conductive layer. The second conductive layer includes the above-described needle-like structure in the surface layer. The first conductive layer and the second conductive layer may have different compositions or the same composition. The first conductive layer and the second conductive layer may be made of the conductive metal oxide described above. If the first electrode includes the porous portion in the surface layer, at least a portion of the first conductive layer may be formed inside recesses in the porous portion.

The conductivity of the conductive layer may be 1 S/cm or more, or 10 S/cm or more. The conductivity of the conductive layer may be 10000 S/cm or less, or 1000 S/cm or less. The conductive layer may be an inorganic layer having a conductivity of 1 S/cm or more.

The thickness of the conductive layer is not particularly limited. The thickness of the conductive layer may be within a range from 0.1 μm to 100 μm (e.g., from 1 μm to 10 μm).

### (Method for Manufacturing Capacitor)

A manufacturing method according to the present embodiment may be hereinafter referred to as a manufacturing method (M). The capacitor (C) can be manufactured using the manufacturing method (M). However, the capacitor (C) may be manufactured using a method other than the manufacturing method (M). Matter described regarding the capacitor (C) can be applied to the manufacturing method (M), and therefore, redundant descriptions will be omitted. Matter described regarding the manufacturing method (M) may be applied to the capacitor (C).

The manufacturing method (M) is a method for manufacturing a capacitor including a first electrode and a dielectric layer formed on a surface of the first electrode. The manufacturing method (M) includes step (i) and step (ii) in this order. The following describes these steps.

Step (i) is a step of forming a conductive layer on the dielectric layer formed on the surface of the first electrode. The conductive layer is the conductive layer described regarding the capacitor (C). In step (i), the conductive layer is formed in such a manner that a surface layer of the conductive layer has the needle-like structure made of an inorganic material. At least the surface layer of the conductive layer can be formed through liquid phase epitaxy. Liquid phase epitaxy makes it possible to form the conductive layer (a crystal layer having electrical conductivity) through crystal growth. At this time, it is possible to form the surface layer having the needle-like structure by selecting conditions of liquid phase epitaxy.

If the surface layer is made of zinc oxide, a zinc oxide layer having the needle-like structure can be formed under the following conditions. First, a solution for liquid phase epitaxy (solution growth) is prepared. Examples of the solution include an aqueous solution in which zinc nitrate and another additive are dissolved. Examples of the additive include hexamethylenetetramine, ammonia, citric acid, ammonium nitrate, aluminum nitrate, gallium nitrate, and indium nitrate. In order to add the above-described additional elements to ZnO, compounds containing the additional elements can be dissolved. The pH of the solution is within a range from 6 to 11, for example. The concentration of zinc nitrate in the solution is within a range from 0.01 mol/L to 2 mol/L, for example. In order to form the surface layer having the needle-like structure, the temperature of the first electrode is set so as to fall within a range from 65° C. to 75° C., for example. The temperature of the solution is set to 75° C. or lower, for example. The temperature of the solution may be within a range from 0° C. to 75° C. (e.g., from 10° C. to 50° C., or from 10° C. to 40° C.).

If the temperature of the first electrode is high (e.g., 85° C. or higher), a columnar structure is formed instead of the needle-like structure. In order to form a zinc oxide layer, conditions under which a dense columnar structure is formed have been conventionally selected. On the other hand, the inventors of the present application found that the needle-like structure is formed at relatively low temperatures. At least the surface layer of the above-described conductive layer is formed under such conditions that the needle-like structure is formed. Note that the average value As of the aspect ratios of needle-like portions in an end portion of the needle-like structure can be changed by changing the temperature of the first electrode, the pH of the solution, and the concentration of the solution, for example.

It is also possible to form a base layer made of zinc oxide before the formation of the zinc oxide layer. For example, the base layer made of zinc oxide may be formed using a gas phase method. Examples of the gas phase method include an atomic layer deposition method (ALD method), a sputtering method, a chemical vapor deposition method (CVD method), and the like. If the base layer is used, it becomes easier to form the zinc oxide layer through liquid phase epitaxy. The ALD method is preferable because the layer is likely to be formed inside recesses in the porous portion.

Similarly to the zinc oxide layer, a conductive layer made of the above-described conductive metal oxide can also be formed through liquid phase epitaxy. In this case, a suitable solution can be selected according to the conductive metal oxide to be formed.

There is no limitation on the method for forming the conductive layer excluding the surface layer having the needle-like structure. The conductive layer excluding the surface layer may be formed using a gas phase method or a liquid phase method. Examples of the gas phase method include the gas phase methods described above. It is also possible to form the entire conductive layer through liquid phase epitaxy, and the entire conductive layer may be formed under the same conditions as the above-described conditions for forming the surface layer. If the entire conductive layer is formed through liquid phase epitaxy, a base layer may be formed on the dielectric layer in advance as described above. Alternatively, it is also possible to form the first conductive layer having a certain thickness on the dielectric layer using the ALD method, and then form the second conductive layer through liquid phase epitaxy. In any case, the surface layer of the conductive layer is formed under such conditions that the needle-like structure is formed. Note that even when the entire conductive layer is formed under such conditions that the needle-like structure is formed, a portion of the conductive layer near the dielectric layer may undergo further growth and may not have the needle-like structure.

If the conductive layer includes the first conductive layer and the second conductive layer, the first conductive layer and the second conductive layer may be formed using the same method or different methods. For example, it is possible to form a first conductive layer and a second conductive layer that have different compositions by using the same method. Alternatively, it is possible to form a first conductive layer and a second conductive layer that have the same composition by using different methods.

Step (ii) is a step of forming the second electrode on the conductive layer. At this time, the second electrode is formed on the needle-like structure of the surface layer of the conductive layer. As a result, the conductive layer and the second electrode are firmly fixed.

The second electrode is formed by using an electrically conductive material. The material of the second electrode is not particularly limited, and may be any material that can be used for an electrode of a capacitor. Although there is no particular limitation on the method for forming the second electrode, it is preferable to use a method that firmly joins the conductive layer and the second electrode. For example, the second electrode may be formed by applying a conductive paste containing conductive particles. Alternatively, the second electrode may be formed using a gas phase method, a plating method, or the like.

The second electrode may include a carbon layer and a silver particle layer that are stacked in this order from the conductive layer side. In this case, first, a carbon paste containing conductive carbon particles is applied. Next, a silver paste containing silver particles is applied. Thereafter, heat treatment is performed to form the carbon layer and the silver particle layer. Thus, the second electrode is formed. Note that it is also possible to perform heat treatment not only after the application of the silver paste but also before the application of the silver paste as necessary. There is no limitation on the carbon paste and the silver paste, and it is possible to use a known carbon paste and a known silver paste.

Through the steps described above, a capacitor element including the first electrode, the dielectric layer, the conductive layer, and the second electrode is formed. After step (ii), leads are connected as necessary and the capacitor element is housed in an enclosure as necessary. Thus, the capacitor (C) is obtained.

Examples of the configuration and components of the capacitor (C) will be described below. Known components may be employed for components other than those of characteristic parts of the present disclosure.

### (First Electrode)

The first electrode can be formed by using a valve metal, an alloy containing a valve metal, a compound containing a valve metal, or the like. Any of these materials may be used alone or in a combination of two or more. Aluminum, tantalum, niobium, or titanium is preferably used as the valve metal. A foil (e.g., a metal foil such as an aluminum foil) made of any of the above-described materials may be used as the first electrode.

A first electrode including a porous portion in its surface can be obtained by, for example, roughening a surface of a metal foil containing a valve metal. Roughening may be performed through electrolytic etching or the like.

The first electrode may be formed by sintering particles of any of the above-described materials. For example, the first electrode may be a sintered body of tantalum. When the first electrode is a sintered body, a porous portion is present in a surface of the first electrode. When the first electrode is a sintered body, the capacitor (C) may include an anode wire with a portion embedded in the sintered body.

### (Dielectric Layer)

The dielectric layer is a layer that has insulating properties and functions as a dielectric. The dielectric layer may be formed by anodizing a valve metal in the surface of the first electrode (e.g., a metal foil). The dielectric layer need only be formed to cover at least a portion of the first electrode. The dielectric layer is usually formed on the surface of the first electrode. When a porous portion is present in the surface of the first electrode, the dielectric layer is formed on the surface of the porous portion of the first electrode.

A typical dielectric layer contains an oxide of a valve metal. The first electrode may be made of a valve metal and the dielectric layer may be made of an oxide of the valve metal. For example, when tantalum is used as the material of the first electrode, the dielectric layer may be a tantalum oxide layer. When aluminum is used as the material of the first electrode, the dielectric layer may be an aluminum oxide layer. However, the dielectric layer is not limited to these, and may be any dielectric layer that functions as a dielectric.

### (Second Electrode)

The second electrode is a layer that has electrical conductivity. The second electrode may be formed by using conductive carbon or a metal. Specifically, the second electrode may be formed by using a carbon paste containing conductive carbon particles or a metal paste containing metal particles. Alternatively, the second electrode may include a layer made of only a metal (a vapor deposition layer or a metal foil). Examples of conductive carbon include graphite, carbon black, graphene flakes, and carbon nanotubes. Examples of the metal paste include a silver paste containing silver particles.

The second electrode may include a first layer formed on the conductive layer, and a second layer formed on the first layer. In this case, the first layer may be a carbon layer containing conductive carbon, and the second layer may be a layer formed by using a metal paste.

### (Lead and Enclosure)

The capacitor (C) includes other constituent elements as necessary. For example, the capacitor (C) may include leads and an enclosure. There is no particular limitation on the leads and the enclosure, and it is possible to use known leads and a known enclosure.

### (Structure of Capacitor (C))

The capacitor (C) may include only one capacitor element. Alternatively, the capacitor (C) may include a plurality of capacitor elements. For example, the capacitor element (C) may include a plurality of capacitor elements connected in parallel to each other. The plurality of capacitor elements (C) are usually connected in parallel in a stacked state, and are covered with the enclosure.

An example of an embodiment according to the present disclosure will be specifically described below with reference to the drawings. The above-described constituent elements can be applied to exemplary constituent elements described below. Also, the example described below can be modified based on the above description. Further, matter described below may be applied to the above embodiment. Also, in the embodiment described below, constituent elements that are not essential to the capacitor according to the present disclosure may be omitted. Note that the drawings described below are schematic drawings and may differ from the actual configuration.

### Embodiment 1

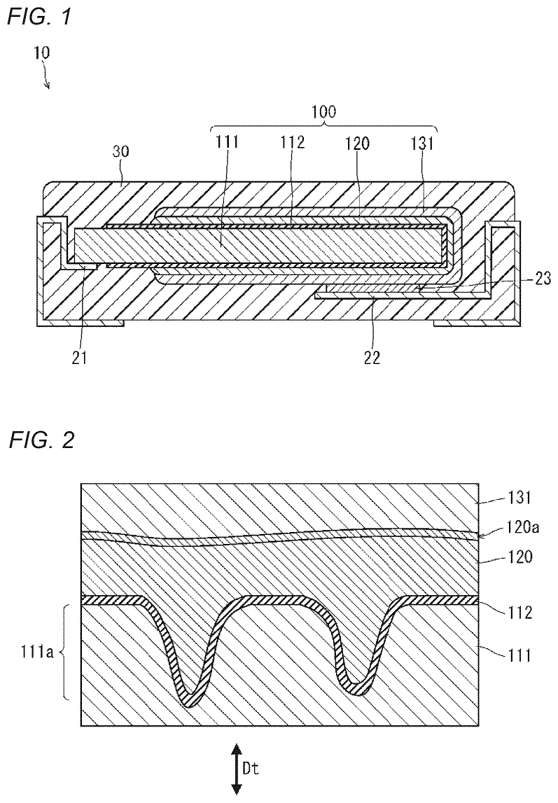

FIG. 1 is a cross-sectional view schematically showing a capacitor according to Embodiment 1. A capacitor 10 shown in FIG. 1 includes a capacitor element 100, a first lead terminal 21, a second lead terminal 22, a metal paste layer 23, and an enclosure 30.

The capacitor element 100 includes a first electrode 111, a dielectric layer 112, a conductive layer 120, and a second electrode 131. The dielectric layer 112 is formed to cover at least a portion of the surface of the first electrode 111. The conductive layer 120 is formed to cover at least a portion of the dielectric layer 112. The second electrode 131 is formed to cover at least a portion of the conductive layer 120. The conductive layer 120 is the above-described conductive layer.

The first lead terminal 21 is connected to the first electrode 111. The second lead terminal 22 is connected to the second electrode 131 via the metal paste layer 23. The metal paste layer 23 is formed by using a metal paste (a silver paste) or the like. The enclosure 30 is formed to cover a portion of the first lead terminal 21, a portion of the second lead terminal 22, and the capacitor element 100. A portion of the first lead terminal 21 and a portion of the second lead terminal 22 are exposed from the enclosure 30, and function as terminals.

FIG. 2 is a schematic cross-sectional view of an example of a portion where the conductive layer 120 is present. FIG. 2 shows the thickness direction Dt of the conductive layer 120. The cross-sectional view of FIG. 2 shows a cross section parallel to the thickness direction Dt of the conductive layer 120. The exemplary first electrode 111 shown in FIG. 2 includes a porous portion 111a in its surface. The actual porous portion 111a may have a more complex shape, but the porous portion 111a is simplified in FIG. 2. A surface layer 120a of the conductive layer 120 has a needle-like structure. However, illustration of the needle-like structure is omitted in FIG. 2.

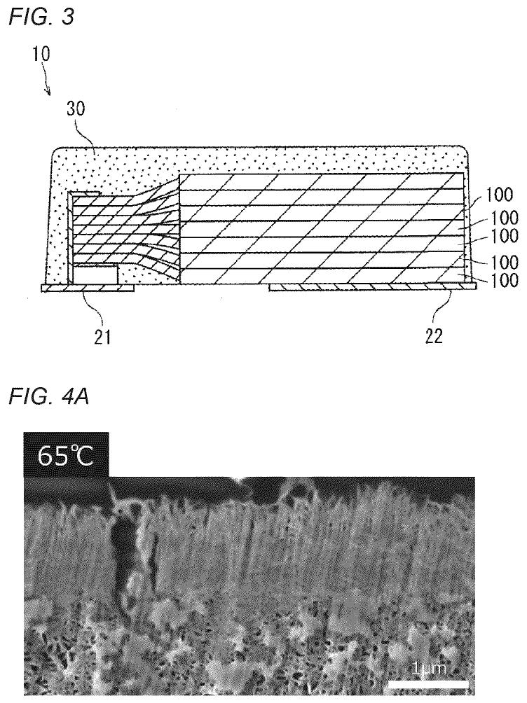

FIG. 1 shows a case where the capacitor 10 includes only one capacitor element 100. However, the capacitor 10 may include a plurality of capacitor elements 100. FIG. 3 shows a schematic cross-sectional view of an example of the capacitor 10 including a plurality of capacitor elements 100. Note that some members are not shown in FIG. 3 to make FIG. 3 easy to read.

The capacitor 10 shown in FIG. 3 includes a plurality of capacitor elements 100 stacked on each other. The plurality of capacitor elements 100 are connected in parallel.

### (Supplementary Notes)

The following technologies are disclosed by the above description.

### (Technology 1)

A capacitor including:
a first electrode;
a dielectric layer formed on a surface of the first electrode;
a conductive layer disposed on the dielectric layer; and
a second electrode disposed on the conductive layer,
wherein the conductive layer includes a needle-like structure made of an inorganic material in a surface layer on the second electrode side.

### (Technology 2)

The capacitor according to technology 1, wherein a portion of the needle-like structure is embedded in the second electrode.

### (Technology 3)

The capacitor according to technology 1 or 2, wherein, in a cross-sectional image of needle-like portions in an end portion of the needle-like structure, an average aspect ratio is within a range from 4.6 to 17.2.

### (Technology 4)

The capacitor according to any one of technologies 1 to 3, wherein, in a cross-sectional image of needle-like portions in an end portion of the needle-like structure, the needle-like portions have a diameter of 0.2 μm or less.

### (Technology 5)

The capacitor according to any one of technologies 1 to 4, wherein at least a portion of needle-like portions in an end portion of the needle-like structure is curved.

### (Technology 6)

The capacitor according to any one of technologies 1 to 5, wherein the conductive layer contains an inorganic material that includes a metal oxide, and the needle-like structure is made of the metal oxide.

### (Technology 7)

The capacitor according to technology 6, wherein the metal oxide is a conductive metal oxide that contains at least one selected from the group consisting of ZnO, TiO₂, indium tin oxide, In₂O₃, SnO₂, Ga₂O₃, MnO₂, NiO₂, CuInO₂, CuCrO₂, CuAlO₂, and CuScO₂ as a main component.

### (Technology 8)

The capacitor according to technology 7, wherein the conductive metal oxide includes oxygen vacancy.

### (Technology 9)

The capacitor according to technology 7, wherein the conductive metal oxide includes an additional element for improving electrical conductivity.

### (Technology 10)

The capacitor according to any one of technologies 1 to 9, wherein the first electrode is an anode, and the second electrode is a cathode.

### (Technology 11)

The capacitor according to any one of technologies 1 to 10, wherein the first electrode is an aluminum foil or a sintered body of tantalum.

### (Technology 12)

The capacitor according to any one of technologies 1 to 11, wherein the first electrode includes a porous portion in a surface layer, the dielectric layer is formed on a surface of the porous portion, and a portion of the conductive layer is within pores in the porous portion.

### (Technology 13)

The capacitor according to any one of technologies 1 to 12, wherein the conductive layer includes a first conductive layer that is in contact with the dielectric layer and a second conductive layer that is in contact with the second electrode, and the second conductive layer has the needle-like structure and a composition different from a composition of the first conductive layer.

### EXAMPLES

The following describes the capacitor (C) according to the present disclosure in more detail using examples.

### (Experiment 1)

In Experiment 1, conductive layers (ZnO layers) were formed under different conditions and evaluated. First, an aluminum foil with a dielectric layer (an aluminum oxide layer) formed on its surface was prepared. The aluminum foil used was an aluminum foil including a porous portion formed by etching on its surface. The aluminum oxide layer was formed by performing chemical conversion treatment on the aluminum foil.

Next, a base layer made of zinc oxide was formed on the dielectric layer using the ALD method. Next, a conductive layer made of zinc oxide (ZnO) was formed on the base layer. Specifically, the aluminum foil with the base layer formed thereon was immersed in a predetermined solution and kept in the solution for 6 hours to form a zinc oxide layer on the base layer.

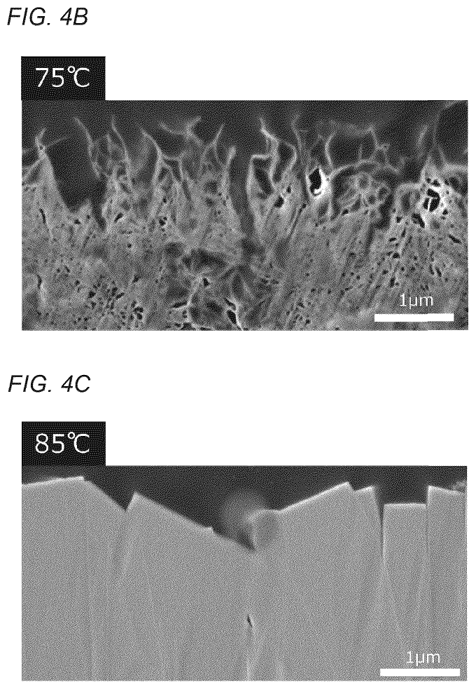

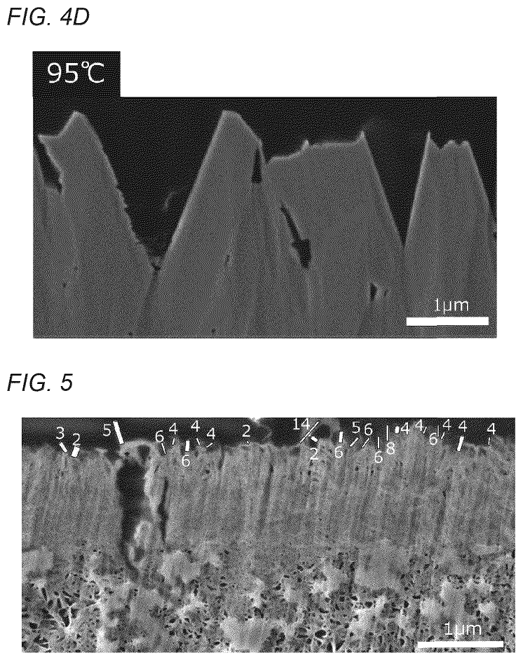

The solution used was an aqueous solution in which zinc nitrate hexahydrate and hexamethylenetetramine were dissolved at a ratio (molar ratio) of 1:1. The concentration of zinc nitrate hexahydrate in the solution was set to 0.05 mol/L. The pH of the solution was set to 6.5 to 7.5. The temperature of the solution was set to room temperature (about 24° C.). During the growth of zinc oxide, a heater was held in contact with a rear surface (a surface opposite to a surface on which zinc oxide was grown) of the aluminum foil to heat the aluminum foil at a constant temperature. In Experiment 1, four types of zinc oxide layers were formed by changing the temperature of the aluminum foil. FIG. 4A shows a cross-sectional image of a surface layer portion of a zinc oxide layer formed by setting the temperature of the aluminum foil to 65° C. Also, FIGS. 4B to 4D show cross-sectional images of surface layer portions of zinc oxide layers formed by setting the temperature of the aluminum foil to 75° C., 85° C., and 95° C., respectively. Note that the cross-sectional images shown in FIGS. 4A to 4D are images of cross sections parallel to the thickness direction Dt of the conductive layer. In other words, the cross-sectional images shown in FIGS. 4A to 4D are images of cross sections perpendicular to the surface of the aluminum foil.

As shown in FIGS. 4A to 4D, needle-like structures were formed when the temperature of the aluminum foil was set so as to fall within a range from 65° C. to 75° C. On the other hand, when the temperature of the aluminum foil was set to 85° C. or 95° C., needle-like structures were not formed, but columnar structures were formed. As shown in FIGS. 4A and 4B, needle-like portions in end portions of the formed needle-like structures were not oriented uniformly, but extended in various directions. Also, at least a portion of the needle-like portions in the end portions of the needle-like structures was curved. Note that, when the temperature of the aluminum foil was set to 50° C. or lower, the growth of zinc oxide was suppressed, and needle-like structures were not formed.

An average value As of the aspect ratios was calculated in the cross-sectional image of needle-like portions in an end portion of the needle-like structure shown in FIG. 4A. The average value As was determined using the following procedure. First, 22 needle-like portions were arbitrarily selected from the end portion of the needle-like structure in the cross-sectional image. Portions that did not branch in the end portion of the needle-like structure were determined to be needle-like portions. Next, the diameter D and length L of each of the selected needle-like portions were determined from the cross-sectional image. The diameter D was determined by measuring the diameter at an arbitrarily selected point on the needle-like portion. If the needle-like portion was curved, the entire length along the curved portion was determined to be the length L of the needle-like portion. Next, the aspect ratio of each needle-like portion was calculated using the following formula: aspect ratio=length L/diameter D. Then, the arithmetic mean of the obtained 22 aspect ratios was calculated to obtain the average value As. FIG. 5 shows aspect ratios of individual needle-like portions. FIG. 5 shows the needle-like portions whose aspect ratios were determined, as bar-shaped figures. As described above, the average value As of the aspect ratios can be determined by arbitrarily selecting 20 or more (e.g., 20) needle-like portions and measuring the needle-like portions.

The average value As of the aspect ratios of needle-like portions in the end portion of the needle-like structure shown in FIG. 4A was 4.6. The average value As of the aspect ratios of needle-like portions in the end portion of the needle-like structure shown in FIG. 4B was 17.2. The diameter of the needle-like portions was 0.2 μm or less in both FIG. 4A and FIG. 4B.

### (Experiment 2)

In Experiment 2, a second electrode was formed on each of conductive layers (ZnO layers) that were formed under different conditions. Then, resistance to peeling between the conductive layer and the second electrode was evaluated.

First, an aluminum foil with a dielectric layer formed on its surface was prepared. The aluminum foil with a dielectric layer formed on its surface was the same as that used in Experiment 1. Next, a zinc oxide layer (a conductive layer) was formed on the dielectric layer using the same method and the same conditions as those described for Experiment 1. At this time, a plurality of types of zinc oxide layers were formed by changing the temperature of the aluminum foil as described for Experiment 1. Next, a second electrode was formed on the zinc oxide layer. Two types of electrodes were each used as the second electrode. One second electrode was formed by stacking a carbon layer and a silver particle layer in this order on the conductive layer. The other second electrode was constituted of only a silver particle layer. Thus, four types of samples A1 to A4 were manufactured. Furthermore, samples R1 to R4 were manufactured as comparative examples using the same method and the same conditions as those used to manufacture the samples A1 to A4, other than that the substrate was changed from the aluminum foil to a glass substrate.

In the manufactured samples, the structure of a surface layer of the zinc oxide layer was observed. Furthermore, a peeling test was performed on the second electrode of the manufactured samples. The peeling test was performed using a so-called tape peeling test. Specifically, a piece of tape was attached to the surface of the second electrode and then peeled off to observe whether or not the second electrode peeled off. Table 1 shows the manufacturing conditions of the samples and evaluation results of the samples in the peeling test.

TABLE 1

| | | Presence or | | Evaluation result |
|---|---|---|---|---|
| | | absence of | | of peeling test |
| | Heating | needle-like | | (whether second |
| | temperature | structure in | Second | electrode peeled |
| Sample | (° C.) | surface layer | electrode | off or not) |
| A1 | 65 | Present | Only silver | Not peeled |
| | | | particle layer | |
| A2 | 65 | Present | Carbon layer/ | Not peeled |
| | | | silver particle | |
| | | | layer | |
| A3 | 75 | Present | Only silver | Not peeled |
| | | | particle layer | |
| A4 | 75 | Present | Carbon layer/ | Not peeled |
| | | | silver particle | |
| | | | layer | |
| R1 | 65 | Absent | Only silver | Peeled |
| | | | particle layer | |
| R2 | 65 | Absent | Carbon layer/ | Not peeled |
| | | | silver particle | |
| | | | layer | |
| R3 | 75 | Absent | Only silver | Partially peeled |
| | | | particle layer | |
| R4 | 75 | Absent | Carbon layer/ | Not peeled |
| | | | silver particle | |
| | | | layer | |

The samples A1 to A4 had the structure of the capacitor (C) according to the present disclosure. In the samples R1 to R4, which are comparative examples, the needle-like structure was not observed in the surface layer of the zinc oxide layer. As shown in Table 1, in the samples A1 to A4, the second electrode did not peel off irrespective of the configuration of the second electrode.

### INDUSTRIAL APPLICABILITY

The present disclosure can be used for a capacitor.

### REFERENCE SIGNS LIST

10: capacitor, 21: first lead terminal, 22: second lead terminal, 30: enclosure, 100: capacitor element, 111: first electrode, 111a: porous portion, 112: dielectric layer, 120: conductive layer, 120a: surface layer, 131: second electrode

1. A capacitor comprising:
a first electrode;
a dielectric layer formed on a surface of the first electrode;
a conductive layer disposed on the dielectric layer; and
a second electrode disposed on the conductive layer,
wherein the conductive layer includes a needle-like structure made of an inorganic material in a surface layer on the second electrode side.

2. The capacitor according to claim 1,
wherein a portion of the needle-like structure is embedded in the second electrode.

3. The capacitor according to claim 1,
wherein, in a cross-sectional image of needle-like portions in an end portion of the needle-like structure, an average aspect ratio is within a range from 4.6 to 17.2.

4. The capacitor according to claim 1,
wherein, in a cross-sectional image of needle-like portions in an end portion of the needle-like structure, the needle-like portions have a diameter of 0.2 μm or less.

5. The capacitor according to claim 1,
wherein at least a portion of needle-like portions in an end portion of the needle-like structure is curved.

6. The capacitor according to claim 1,
wherein the conductive layer contains an inorganic material that includes a metal oxide, and
the needle-like structure is made of the metal oxide.

7. The capacitor according to claim 6,
wherein the metal oxide is a conductive metal oxide that contains at least one selected from the group consisting of ZnO, TiO₂, indium tin oxide, In₂O₃, SnO₂, Ga₂O₃, MnO₂, NiO₂, CulnO₂, CuCrO₂, CuAlO₂, and CuScO₂ as a main component.

8. The capacitor according to claim 7,
wherein the conductive metal oxide includes oxygen vacancy.

9. The capacitor according to claim 7,
wherein the conductive metal oxide contains an additional element for improving electrical conductivity.

10. The capacitor according to claim 1,
wherein the first electrode is an anode, and the second electrode is a cathode.

11. The capacitor according to claim 1,
wherein the first electrode is an aluminum foil or a sintered body of tantalum.

12. The capacitor according to claim 1,
wherein the first electrode includes a porous portion in a surface layer,
the dielectric layer is formed on a surface of the porous portion, and
a portion of the conductive layer is within pores in the porous portion.

13. The capacitor according to claim 1,
wherein the conductive layer includes a first conductive layer that is in contact with the dielectric layer and a second conductive layer that is in contact with the second electrode, and
the second conductive layer has the needle-like structure and a composition different from a composition of the first conductive layer.
